(19) United States
(12) Patent Application Publication
(10) Pub. No.: US 2025/0070504 A1
(43) Pub. Date: Feb. 27, 2025

(54) SOCKET, PLUG, CONNECTOR ASSEMBLY, DATA CABLE, AND SMART GLASSES

(71) Applicant: BEIJING UNICORN TECHNOLOGY CO., LTD., Beijing (CN)

(72) Inventors: Yue HE, Beijing (CN); Tongfu ZHANG, Beijing (CN)

(21) Appl. No.: 18/723,873

(22) PCT Filed: Dec. 27, 2022
(86) PCT No.: PCT/CN2022/142250

§ 371 Date: Jun. 25, 2024

(30) Foreign Application Priority Data
Dec. 27, 2021 (CN) 202111613948.0

(51) Int. Cl. H01R 13/62; H01R 13/639

(52) U.S. Cl. CPC H01R 13/6205; H01R 13/639

(57) ABSTRACT

Provided in the present disclosure are a socket, a plug, a connector assembly, a data cable, and smart glasses. The socket includes a connecting groove, a socket terminal and a first magnetic component. The connecting groove includes an outer groove portion and an inner groove portion, wherein the inner groove portion is in communication with the outer groove portion, and a limiting surface is formed between the inner groove portion and the outer groove portion. The socket terminal is arranged in the inner groove portion. The first magnetic component is arranged in the inner groove portion. The socket is configured in such a way that when a plug having a protruding portion and a second magnetic component is placed into the connecting groove, the plug is movable relative to the socket under the interaction between the first magnetic component and the second magnetic component.

### CROSS-REFERENCES TO RELATED APPLICATIONS

The present disclosure is a national phase application of International Application No. PCT/CN2022/142250, filed on Dec. 27, 2022, which claims priority to Chinese patent application No. 202111613948.0 filed with the Chinese Patent Office on Dec. 27, 2021, the entireties of which are herein incorporated by reference.

### FIELD

The present disclosure relates to the technical field of devices for electrical connection, and in particular, to a socket, a plug, a connector assembly, a data cable, and smart glasses.

### BACKGROUND

In the related art, an electronic consumer product typically needs to be provided with an interface (e.g., USB interface) for connection with a data cable to transmit data and/or power. Some interfaces are connected to data cables in a magnetic attraction manner. Compared with traditional plug-in connection, magnetic connection is easier to use. First, a user may perform operation with one hand. Further, the user may move a data cable connector to the vicinity of the interface without seeing the interface and the data cable connector, such that the data cable connector and the interface are connected automatically due to magnetic attraction. The user experience is better than that of the traditional manual plug-in connection mode.

A connection structure of the conventional magnetic connection mode is usually not stable enough, and disconnection may occur under the action of an external force. Existing technology usually makes the connection more stable by adding a clamping structure. However, if the clamping structure is added, it still requires a manual way to implement clamping. Two steps are needed to accomplish the connection between the data cable connector and the interface. First, the data cable connector is brought to the vicinity of the interface, such that magnets of the data cable connector and the interface attract and engage each other. Second, clamping is performed manually so that the magnetic connection is firm and stable. This addition of the clamping structure that requires manual operation results in low convenience and a mediocre user experience.

### SUMMARY

An object of the present disclosure is providing a socket, a plug, a connector assembly, a data cable, and smart glasses.

To achieve the above object, the present disclosure provides the following technical solution.

According to embodiments of a first aspect of the present disclosure, a socket is provided. The socket includes: a connecting groove, a socket terminal, and a first magnetic component. The connecting groove includes an outer groove portion and an inner groove portion, wherein the inner groove portion is in communication with the outer groove portion, and a limiting surface is formed between the inner groove portion and the outer groove portion. The socket terminal is arranged in the inner groove portion. The first magnetic component is arranged in the inner groove portion. The socket is configured in such a way that when a plug having a protruding portion and a second magnetic component is placed into the connecting groove, the plug is movable relative to the socket under the interaction between the first magnetic component and the second magnetic component, such that the protruding portion is clamped onto the limiting surface of the socket, and the socket terminal comes into electrical contact with a plug terminal of the plug, so as to transmit at least one of data and electric energy.

According to embodiments of a second aspect of the present disclosure, a plug is provided. The plug includes: a plug body having a plug terminal and a second magnetic component surrounding the plug terminal, the second magnetic component being formed with a protruding portion, wherein when the plug body is placed into a socket with a connecting groove, the plug body is movable relative to the socket under the interaction between a first magnetic component of the socket and the second magnetic component, such that the protruding portion is clamped onto a limiting surface in the connecting groove, and the plug terminal comes into electrical contact with a socket terminal in the socket, so as to transmit at least one of data and electric energy.

According to embodiments of a third aspect of the present disclosure, a connector assembly is provided, the connector assembly including the socket and the plug described above. When the plug is placed into the connecting groove, the plug is movable relative to the socket under the interaction between the first magnetic component and the second magnetic component, such that the protruding portion is clamped onto the limiting surface of the socket, and the socket terminal comes into electrical contact with a plug terminal of the plug, so as to transmit at least one of data and electric energy.

According to embodiments of a fourth aspect of the present disclosure, a data cable is provided, the data cable including a cable and the plug described above, the cable being electrically connected to the plug.

According to embodiments of a fifth aspect of the present disclosure, smart glasses are provided, the smart glasses including a spectacle frame and the socket described above, the spectacle frame having a frame and a temple, the temple being connected to the frame, and the socket being connected to the temple.

The technical solution of the present disclosure is further described in detail below in conjunction with the accompanying drawings and embodiments.

### BRIEF DESCRIPTION OF THE DRAWINGS

The drawings constituting a part of the specification describe embodiments of the present disclosure, and together with the description, serve to explain the principle of the present disclosure.

With reference to the accompanying drawings, the present disclosure can be understood more clearly according to the following detailed description:

FIG. 1 is a schematic diagram of a first cooperation structure of a connector assembly provided in embodiments of the present disclosure.

FIG. 2 is a sectional view along direction A-A in FIG. 1.

FIG. 3 is a partial sectional view of a socket provided in embodiments of the present disclosure.

FIG. 4 is a schematic diagram of a plug and a socket of a connector assembly provided in embodiments of the present disclosure in a plug-in state.

FIG. 5 is a sectional view along a direction B-B in FIG. 4.

FIG. 6 is a schematic diagram of a second cooperation structure of a connector assembly provided in embodiments of the present disclosure.

FIG. 7 is a sectional view along direction C-C in FIG. 6.

FIG. 8 is a sectional view of a socket of a third cooperation structure of a connector assembly provided in embodiments of the present disclosure.

FIG. 9 is a side view of smart glasses provided in embodiments of the present disclosure.

FIG. 10 is a schematic diagram of a first state in which smart glasses provided in embodiments of the present disclosure are connected with a data cable.

FIG. 11 is a schematic diagram of a second state in which smart glasses provided in embodiments of the present disclosure are connected with a data cable.

FIG. 12 is a schematic diagram of a third state in which smart glasses provided in embodiments of the present disclosure are connected with a data cable.

Reference numerals: 100, smart glasses; 1, connector assembly; 11, socket; 111, connecting groove; 1111, outer groove portion, 1111a, outer groove opening; 1112, inner groove portion; 1112a, inner groove opening; 1112b, main groove portion; 1112c, extension clamping groove; 1112d, recess; 1113, limiting surface; 112, socket terminal; 113, first magnetic component; 13, plug; 131, plug seat; 132, plug body; 1321, plug terminal; 1322, second magnetic component; 1322a, protruding portion; 1323, plug main body; 1324, sunken portion; 2, spectacle frame; 21, frame; 22, temple; 221, temple main body; 222, ear hanging portion; 3, cable.

It is to be noted that these drawings and text description are not intended to limit the scope of conception of the present disclosure in any way, but to explain the concepts of the present disclosure for those skilled in the art by referring to specific embodiments.

### DETAILED DESCRIPTION OF THE DISCLOSURE

To make the object, technical solution and advantages of embodiments of the present disclosure clearer, the technical solution in the embodiments will be described below clearly and completely with reference to the drawings in the embodiments of the present disclosure. The following embodiments are used for illustrating the present disclosure, but not limiting the scope of the present disclosure.

In description of the present disclosure, it is to be noted that such terms “upper”, “lower”, “inner”, “outer”, etc. that denote orientation or location relations are based on orientation or location relations illustrated in the drawings, and are only intended to facilitate describing the present disclosure and simplify description, instead of indicating or implying the denoted apparatuses necessarily have specific orientations or are constructed and operated in specific orientations, and thus they should not be construed as limiting the present disclosure.

In description of the present disclosure, it is to be noted that unless otherwise explicitly specified and defined, the terms “mount” and “connect” should be construed broadly. For example, such a term may denote fixed connection, or detachable connection, or integrated connection; mechanical connection, or electric connection; direct connection, or indirect connection via an intermediate medium. For those of ordinary skill in the art, specific meanings of the above terms in the present disclosure may be understood based on specific circumstances.

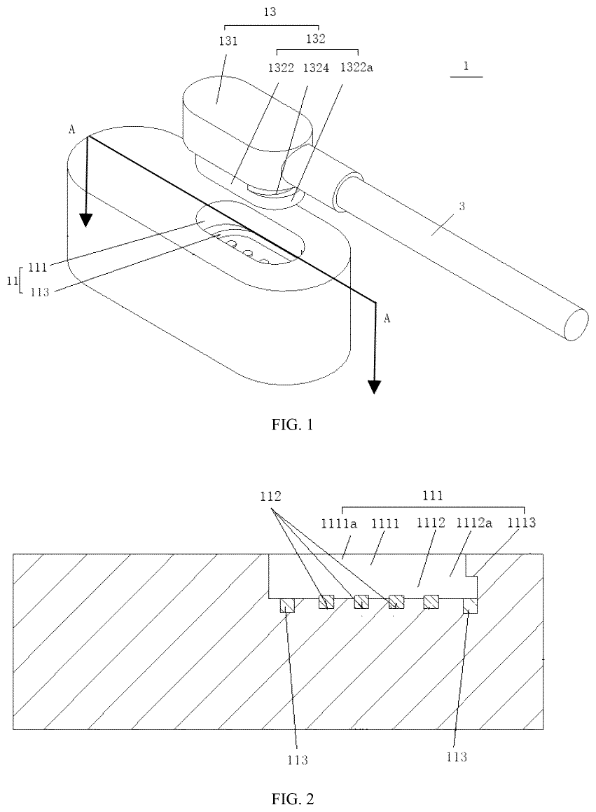

Referring to FIGS. 1 to 8, embodiments in a first aspect of the present disclosure provide a socket 11. It includes a connecting groove 111, a socket terminal 112 and a first magnetic component 113. The connecting groove 111 includes an outer groove portion 1111 and an inner groove portion 1112, the inner groove portion 1112 is in communication with the outer groove portion 1111, and a limiting surface 1113 is formed between the inner groove portion 1112 and the outer groove portion 1111. The socket terminal 112 is arranged in the inner groove portion 1112. The first magnetic component 113 is arranged in the inner groove portion 1112. The socket 11 is configured in such a way that when a plug having a protruding portion 1322a and a second magnetic component 1322 is placed into the connecting groove 111, the plug 13 is movable relative to the socket under the interaction between the first magnetic component 113 and the second magnetic component 1322, such that the protruding portion 1322a is clamped onto the limiting surface 1113 of the socket, and the socket terminal 112 comes into electrical contact with a plug terminal 1321 of the plug 13, so as to transmit at least one of data and electric energy.

The socket 11 of the present disclosure is provided with the outer groove portion 1111 and the inner groove portion 1112 so as to form the limiting surface 1113 therebetween. To connect the plug 13 to the socket 11, the plug 13 is directly placed into the connecting groove 111, such that the protruding portion 1322a can automatically slide to a side of the limiting surface 1113 and be clamped onto the limiting surface 1113 under the action of mutual attraction of the first magnetic component 113 and the second magnetic component 1322. Because the two magnetic components can maintain an attraction state and the protruding portion 1322a can be stopped by the limiting surface 1113, the connection structure of the plug 13 and the socket 11 is stable and not prone to detachment. To separate the plug 13 from the socket 11, it only needs to apply a force to push or rotate the plug 13, causing the protruding portion 1322a of the plug 13 to slide out to separate from the limiting surface 1113, such that the plug 13 may be disengaged from the socket 11, and at that time the plug 13 may be taken out directly. The plugging-in and unplugging processes of the plug 13 and the socket 11 may be implemented by operation with one hand, achieving a good user experience.

In some embodiments, the inner groove portion 1112 includes a main groove portion 1112b and an extension clamping groove 1112c that are in communication with each other. The main groove portion 1112b is in communication with the outer groove portion 1111, and the limiting surface 1113 is formed between the extension clamping groove 1112c and the outer groove portion 1111. The socket terminal 112 is arranged in the main groove portion 1112b. The first magnetic component 113 is arranged in the main groove portion 1112b and the extension clamping groove 1112c. It may be understood that when a plug having a protruding portion 1322a and a second magnetic component 1322 is placed into the connecting groove 111, the protruding portion 1322a may extend into the extension clamping groove 1112c to stably connect the socket and the plug.

Optionally, the first magnetic component 113 is closer to an outer edge of the socket than the socket terminal 112. That is to say, the position of the socket terminal 112 is close to the center of the socket, and the first magnetic component 113 may be arranged at an outer side of the socket terminal 112. In optional examples, the first magnetic component 113 may surround the socket terminal 112.

In practical operations, the plug 13 may be placed near the socket 11 by operation with one hand. Usually, the size of the outer groove portion 1111 is larger than that of the plug 13. After the plug 13 falls into the outer groove portion 1111, it may move under the action of magnetic attraction to clamp the protruding portion 1322a onto the limiting surface 1113.

In some examples, the extension clamping groove is defined between the limiting surface 1113 and the inner groove portion 1112, and after the plug 13 moves relative to the socket 11, the protruding portion 1322a enters the extension clamping groove so as to be clamped onto the limiting surface 1113 of the socket.

In some examples, a plane where the limiting surface 1113 is located is perpendicular to an extension direction of an attraction force generated when the first magnetic component 113 and the second magnetic component 1322 are magnetically attracted and connected to each other. The protruding portion 1322a is clamped onto the limiting surface 1113, such that the protruding portion 1322a cannot move relative to the socket 11 in a direction of connection between the first magnetic component 113 and the second magnetic component 1322, so as to make the connection between the plug 13 and the socket 11 stable.

It is to be noted that the “magnetic component” defined in the present disclosure refers to a member capable of directly or indirectly generating a magnetic attraction force. The magnetic absorption component may be made of any one or more of transition elements iron, cobalt, nickel and alloys thereof.

Referring to FIG. 2, in some possible embodiments, the outer groove portion 1111 has an outer groove opening 1111a, the inner groove portion 1112 has an inner groove opening 1112a in communication with the outer groove portion 1111. The outer groove opening 1111a and the inner groove opening 1112a are arranged in one of the following two ways: projections of the outer groove opening 1111a and the inner groove opening 1112a on a horizontal plane have a rotational angle difference; and projections of the outer groove opening 1111a and the inner groove opening 1112a on a horizontal plane have a displacement difference.

It may be understood that the term “horizontal plane” herein may be considered as a plane perpendicular to a depth direction of the connecting groove 111. The term “outer groove opening” may be understood as a contour of a rim of the outer groove portion 1111, and the term “inner groove opening” may be understood as a contour of a rim of the inner groove portion 1112.

Optionally, in the depth direction of the connecting groove 111, the projection of the contour of the rim of the outer groove portion 1111 coincides with a portion of the projection of the contour of the rim of the inner groove portion 1112, and a projection of a contour of a portion of the rim of the inner groove portion 1112 exceeds the projection of the contour of the rim of the outer groove portion 1111. In terms of the projections in the depth direction of the connecting groove 111, a portion of the inner groove portion 1112 that exceeds the outer groove portion 1111 may be used to form the limiting surface 1113.

In embodiments of the present disclosure, there is a positional or angular deviation between the position of the outer groove opening 1111a and the position of the inner groove opening 1112a of the connecting groove 111, thereby forming the limiting surface 1113. When the plug 13 is placed into the connecting groove 111, the first magnetic component 113 and the second magnetic component 1322 may attract each other, such that the plug 13 translates or rotates until the protruding portion 1322a is clamped onto the limiting surface 1113.

Referring to FIGS. 1, 2, 3, and 5, in some possible embodiments, both the outer groove opening 1111a and the inner groove opening 1112a are strip-shaped, and the projections of the inner groove opening 1112a and the outer groove opening 1111a on the horizontal plane have a distance difference in a length direction of the outer groove opening 1111a. It may be understood that the term “strip-shaped” herein means that a cross-sectional shape of the groove opening extends in two directions, and its dimension in one direction is larger than that in the other direction.

In this embodiment, the outer groove opening 1111a and the inner groove opening 1112a may have the same width, and they have a distance difference only in the length direction, thereby forming the limiting surface 1113 on one side in the length direction of the inner groove opening 1112a. When the plug 13 is placed into the connecting groove 111, the first magnetic component 113 and the second magnetic component 1322 may attract each other, and the plug 13 translates in the length direction of the inner groove portion 1112 until the protruding portion 1322a of the plug 13 is clamped onto the limiting surface 1113.

In embodiments of the present disclosure, it is also possible that the projections of the inner groove portion 1112a and the outer groove portion 1111a on the horizontal plane have a distance difference in a width direction of the outer groove portion 1111a, thereby forming a limiting surface 1113 having a length equal to the length of the inner groove portion 1112. Accordingly, the plug 13 may be provided with a protruding portion 1322a on a side of its lengthwise side, and the limiting surface 1113 can similarly have an effect of clamping the protruding portion 1322a.

In some possible embodiments, in a first direction, an end of the outer groove portion 1111 is flush with an end of the inner groove portion 1112, while in a second direction opposite the first direction, an end of the inner groove portion 1112 extends beyond an end of the outer groove portion 1111. A portion of the inner groove portion 1112 extending beyond the outer groove portion 1111 defines an extension clamping groove, and the limiting surface 1113 is a wall of the extension clamping groove.

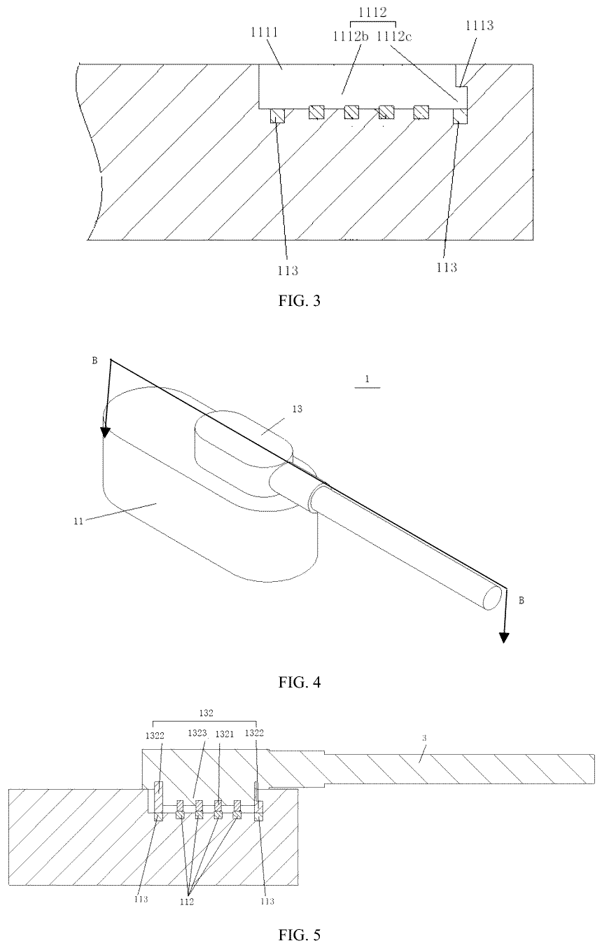

Referring to FIG. 3, in some possible embodiments, the inner groove portion 1112 has a main groove portion 1112b and an extension clamping groove 1112c. The main groove portion 1112b is in communication with the outer groove portion 1111, the extension clamping groove 1112c is in communication with an end of the main groove portion 1112b in the length direction, and the limiting surface 1113 is formed between the extension clamping groove 1112c and the outer groove portion 1111. When the plug 13 having a protruding portion 1322a on one side in the length direction is placed into the connecting groove 111, the plug 13 is movable linearly relative to the socket 11 under the interaction between the first magnetic component 113 and the second magnetic component 1322, such that the protruding portion 1322a is clamped into the extension clamping groove 1112c.

In this embodiment, the main groove portion 1112b is located directly below the outer groove portion 1111, and the extension clamping groove 1112c and the outer groove portion 1111 are arranged in different positions so that the limiting surface 1113 is formed between the extension clamping groove 1112c and the outer groove portion 1111. The extension clamping groove 1112c may match the shape of the protruding portion 1322a. The protruding portion 1322a may be embedded in the extension clamping groove 1112c, and the clamping cooperation structure of the protruding portion 1322a and the extension clamping groove 1112c is stable and not prone to detachment.

Referring to FIGS. 6, 7, and 8, in some possible embodiments, the projections of the outer groove opening 1111a and the inner groove opening 1112a on the horizontal plane have a rotational angle difference to form an extension clamping groove 1112c in the inner groove portion 1112. The rotation center is arranged in one of the following two ways: the rotation center is a center point of the projections of the outer groove opening 1111a and the inner groove opening 1112a on the horizontal plane; and the rotation center is an intersection point of outer contour lines of the projections of the outer groove opening 1111a and the inner groove opening 1112a on the horizontal plane.

In this embodiment, the projections of the outer groove opening 1111a and the inner groove opening 1112a on the horizontal plane have a rotational angle difference, and when the plug is placed into the connecting groove 111, the plug 13 is movable or swingable relative to the socket 11 under the interaction between the first magnetic component 113 and the second magnetic component 1322, such that the protruding portion 1322a is clamped into the extension clamping groove 1112c. Such a rotation or swing clamping cooperation structure is more applicable to smart glasses 100. For example, a temple of the smart glasses 100 has an arc-shaped ear hanging portion 222. The socket 11 is provided on the ear hanging portion 222. The ear hanging portion 222 is an elongate strip structure. Limited by the shape of the ear hanging portion 222, the socket 11 can only be provided in a manner of extending in a length direction of the ear hanging portion 222. In this case, when the plug 13 connected to a cable 3 is inserted into the socket 11, the plug 13 will rotate or swing at a certain angle, thereby adjusting the direction of the cable 3, such that the cable 3 enters a natural sagging state. In this way, the smart glasses 100 and the cable 3 have a neat form during use of the smart glasses 100, which significantly improves the user experience.

Referring to FIGS. 6 and 7, in some possible embodiments, the rotation center is a center point of the projections of the outer groove opening 1111a and the inner groove opening 1112a on the horizontal plane. The inner groove portion 1112 has a main groove portion 1112b and two extension clamping grooves 1112c. The main groove portion 1112b is in communication with the outer groove portion 1111, the extension clamping grooves 1112c are in communication with the main groove portion 1112b, and the two extension clamping grooves 1112c are respectively provided on two sides of the outer groove opening 1111a in a diagonal direction. When the plug 13 having a protruding portion 1322a on each of the two sides in the diagonal direction is placed into the connecting groove 111, the plug is rotatable relative to the socket under the interaction between the first magnetic component 113 and the second magnetic component 1322, such that the two protruding portions 1322a are respectively clamped into the two extension clamping grooves 1112c.

In this embodiment, the first magnetic component 113 may be disposed circumferentially along a rim of the inner groove portion 1112, and the second magnetic component 1322 is disposed circumferentially along the plug 13. When the plug 13 is placed into the connecting groove 111, the first magnetic component 113 and the second magnetic component 1322 attract each other, and the plug 13 will rotate around the center of the first magnetic component 113 until the second magnetic component 1322 and the first magnetic component 113 are aligned. At this point, the two protruding portions 1322a on the plug 13 are respectively clamped in the two extension clamping grooves 1112c. Because the two protruding portions 1322a are located on the two sides of the plug 13 in the diagonal direction, two ends of the plug 13 are both fixed in a clamped manner, and thus the connection structure of the plug and the socket is highly stable and not prone to detachment.

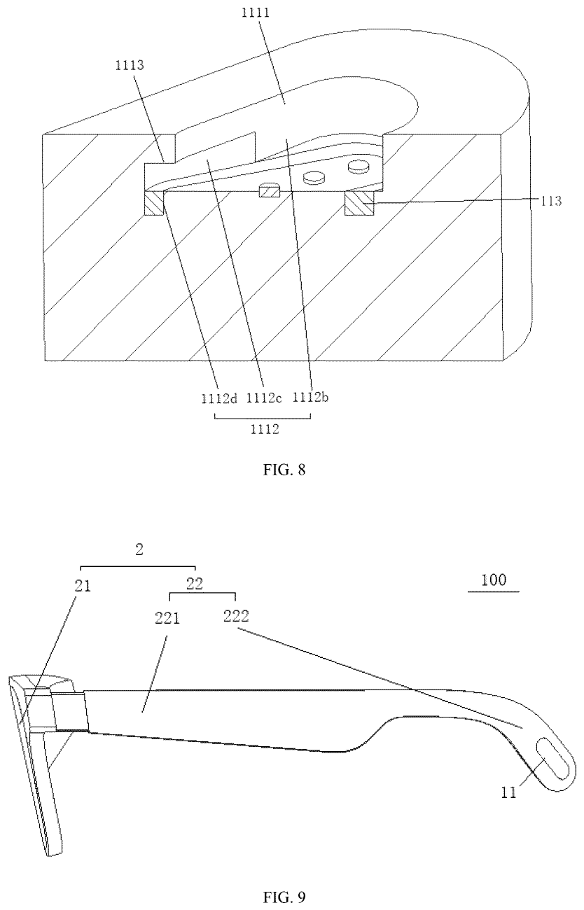

Referring to FIG. 8, in some possible embodiments, the rotation center is an intersection point of outer contour lines of the projections of the outer groove opening 1111a and the inner groove opening 1112a on the horizontal plane. The inner groove portion 1112 has a main groove portion 1112b and an extension clamping groove 1112c. The main groove portion 1112b is in communication with the outer groove portion 1111, the extension clamping groove 1112c is in communication with the main groove portion 1112b, and the extension clamping groove 1112c is located on one side of the outer groove opening 1111a in a diagonal direction. When the plug having the protruding portion 1322a on one side in the diagonal direction is placed into the connecting groove 111, one end of the plug swings, under the interaction between the first magnetic component 113 and the second magnetic component 1322, until the protruding portion 1322a is clamped into the extension clamping groove 1112c.

In this embodiment, the inner groove portion 1112 is provided only with one extension clamping groove 1112c, which differs from the above solution with two extension clamping grooves 1112c in that when the plug 13 is placed into the connecting groove 111, the plug 13 will rotate around the intersection point of the outer contour lines of the projections of the outer groove opening 1111a and the inner groove opening 1112a on the horizontal plane under the action of mutual attraction of the first magnetic component 113 and the second magnetic component 1322, which may mean that the plug 13 rotates (swings) around an end point of a longitudinal axis of the first magnetic component 113 until the protruding portion 1322a at the end is clamped into the extension clamping groove 1112c.

In some possible embodiments, the first magnetic component 113 is disposed circumferentially along a rim of the inner groove portion 1112, a recess 1112d is provided along a rim of a bottom wall of the inner groove portion 1112, and the first magnetic component 113 is embedded in the recess 1112d.

In this embodiment, the first magnetic component 113 is closed ring-shaped, is provided in a manner of extending around a circumference of the inner groove portion 1112, has a large size and weight, and provides a large attraction to the plug 13, such that the plug 13 can be clamped into the extension clamping groove 1112c, and its clamped position is maintained unchanged, which reduces the probability of the protruding portion 1322a accidentally slipping out of the clamping slot 1112c. In addition, in embodiments of the present disclosure, by providing the recess 1112d in the bottom wall of the inner groove portion 1112, such that the first magnetic component 113 can be embedded in the interior of the recess 1112d and does not protrude out of the bottom wall of the inner groove portion 1112, but provides a smooth transition to a surface of the bottom wall of the inner groove portion 1112, it does not occupy the space of the inner groove portion 1112, leaving a sufficient accommodating and motion space for the plug 13.

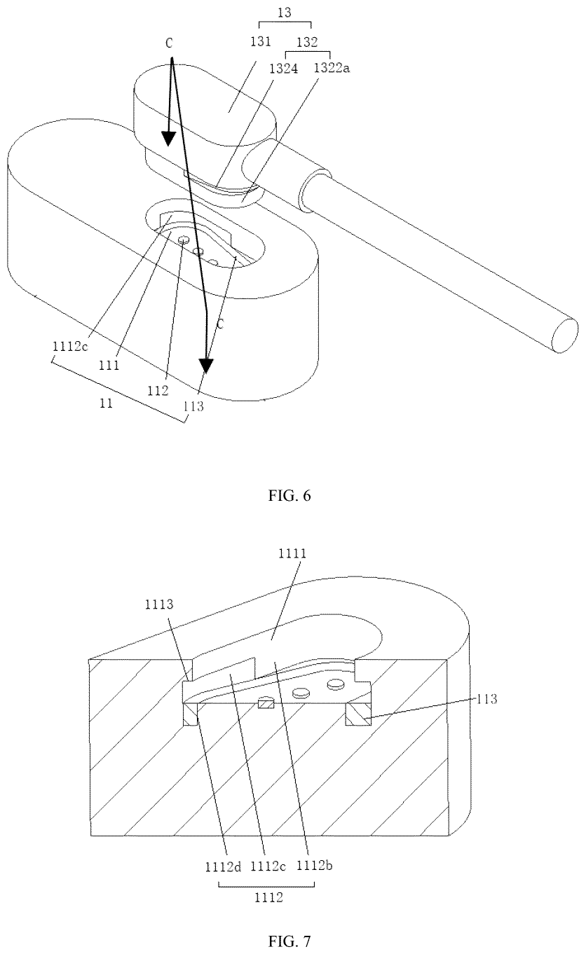

Referring to FIG. 5, embodiments of a second aspect of the present disclosure provide a plug 13 that cooperates with the socket 11 in the embodiments of the first aspect described above. The plug 13 includes a plug body 132. The plug body 132 has a plug terminal 1321 and a second magnetic component 1322 surrounding the plug terminal 1321. The second magnetic component 1322 is formed with a protruding portion 1322a. When the plug body 132 is placed into the connecting groove 111 of the socket 11, the plug body 132 is movable relative to the socket 11 under the interaction between the first magnetic component 113 and the second magnetic component 1322, such that the protruding portion 1322a is clamped onto the limiting surface 1113 of the socket, and the plug terminal 1321 comes into electrical contact with the socket terminal 112, so as to transmit at least one of data and electric energy.

In this embodiment, the plug body 132 has a plug main body 1323, and the second magnetic component 1322 is disposed circumferentially along an outer wall of the plug main body 1323. The second magnetic component 1322 may be closed ring-shaped, with a long extension length, a large volume, and correspondingly a large magnetic attraction force, thereby increasing a magnetic attraction force between the second magnetic component and the first magnetic component 113, so the connection structure of the plug 13 and the socket 11 is stable and not prone to detachment.

Referring to FIG. 1, the plug 13 may include a plug seat 131. The plug body 132 is connected to the plug seat 131. The second magnetic component 1322 is provided with an sunken portion 1324 on a side close to the plug seat 131 to form a protruding portion 1322a on a side of the sunken portion 1324 away from the plug seat 131. It may be understood that the protruding portion 1322a is a portion of the second magnetic component 1322, and also a portion having a magnetic attraction capability.

In some possible embodiments, the protruding portion 1322a is arranged in one of the following three ways: the protruding portion 1322a is located on one side of the plug body 132 in a length direction; the protruding portion 1322a is located on one side of the plug body 132 in a diagonal direction; and the protruding portion 1322a is located on two sides of the plug body 132 in the diagonal direction.

In each of the above three ways of arrangement of the protruding portion 1322a, the socket 11 has a connecting groove 111 with a corresponding cooperation structure to achieve quick plugging-in and unplugging of the plug 13 and the socket 11. All of the three ways of arrangement are described in detail in the embodiments of the first aspect, and will not be repeated in embodiments of this aspect.

Referring to FIG. 1, in some possible embodiments, the plug 13 includes a plug seat 131. The plug body 132 is connected to the plug seat 131. The plug seat 131 has a cross-section larger than that of the plug body 132. The plug is configured in such a way that in a state where the plug body 132 is connected to the connecting groove 111, the plug seat 131 covers the connecting groove 111.

In this embodiment, the plug seat 131 can cover the outer groove opening 1111a of the connecting groove 111. In addition to having shielding and aesthetic functions, the plug seat 131 can block the outer groove opening 1111a of the connecting groove 111 to prevent foreign matters and impurities from entering the interior of the connecting groove 111, thus achieving a function of protecting the internal structure of the connecting groove 111, improving the quality of a product, and prolonging the service life of the product.

Referring to FIGS. 1 and 4, embodiments of a third aspect of the present disclosure further provide a connector assembly 1 including the socket 11 in the embodiments of the first aspect described above and the plug 13 in the embodiments of the second aspect described above. When the plug 13 is placed into the connecting groove 111, the plug is movable relative to the socket under the interaction between the first magnetic component 113 and the second magnetic component 1322, such that the protruding portion 1322a is clamped onto the limiting surface 1113 of the socket, and the socket terminal 112 comes into electrical contact with the plug terminal 1321 of the plug, so as to transmit at least one of data and electrical energy.

The socket 11 of the connector assembly 1 may be provided on an electronic device, which may be smart glasses. The plug 13 of the connector assembly 1 may be provided at an end of the cable 3, and the plug 13 is electrically connected to the cable 3. To connect the plug 13 to the socket 11, the plug 13 is directly placed into the connecting groove 111, such that the protruding portion 1322a can automatically slide to a side of the limiting surface 1113 and be clamped onto the limiting surface 1113 under the action of mutual attraction of the first magnetic component 113 and the second magnetic component 1322. Because the two magnetic components can maintain a connected state, the connection structure of the plug 13 and the socket 11 is stable and not prone to detachment. In the case of the connector assembly 1 provided in this embodiment, to separate the plug 13 and the socket 11, it only needs to apply a force to push out or rotate the plug 13, causing the protruding portion 1322a of the plug 13 to be released from the restriction of the limiting surface 1113, such that the plug 13 is disengaged from the socket 11. Both the plugging-in and unplugging of this connector assembly 1 may be implemented by operation with one hand, and the operation may be performed out of the field of view, making it convenient to use and resulting in a good user experience.

Referring to FIG. 4, embodiments of a fourth aspect of the present disclosure provide a data cable including: a cable 3, and the plug 13 in the embodiments of the second aspect described above. The cable 3 is electrically connected to the plug 13. The data cable is used in cooperation with an electronic device having the socket 11 in the embodiments of the first aspect described above. The plug 13 of the data cable can be inserted into the socket 11 of the electronic device to transmit at least one of data and electrical energy.

Referring to FIGS. 9 to 12, embodiments of a fifth aspect of the present disclosure provide smart glasses 100 including: a spectacle frame 2, and the socket 11 in the embodiments of the first aspect described above. The spectacle frame 2 has a frame 21 and a temple 22. The temple 22 is connected to the frame 21. The socket 11 is connected to the temple 22.

The smart glasses 100 need to be connected to a power source or an external device by using a data cable to implement charging or data transmission. The external device may be an electronic device such as a cell phone, a tablet computer, or a smart watch. The smart glasses may display data of the external device, and the external device may be used to control what the smart glasses display.

In some possible application scenarios, a user wears the smart glasses 100 on his head and hold a mobile terminal by hand, and the smart glasses 100 are connected to the mobile terminal via a data cable. Since the hand is generally located below the head, it is expected that the data cable naturally sags as much as possible instead of extending transversely.

The temple 22 has a temple main body 221 and an ear hanging portion 222 connected to the temple main body 221. The socket 11 is connected to the ear hanging portion 222. The ear hanging portion 222 is an elongate strip structure. Limited by the shape of the ear hanging portion 222, the socket 11 is generally provided in a manner of extending in a length direction of the ear hanging portion 222. Referring to FIG. 9, the socket 11 is tilted when the glasses are placed upright on a table.

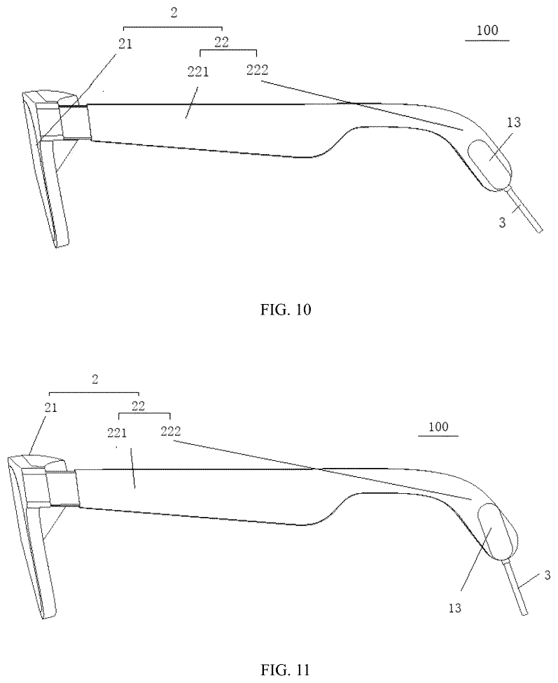

See FIGS. 10 and 1, which are state diagrams of smart glasses 100 and a data cable after a plug 13 is inserted into a socket 11 in the case where the socket 11 is a socket 11 with a displacement difference between projections of an outer groove opening 1111a and an inner groove opening 1112a on a horizontal plane in the embodiments of the first aspect described above.

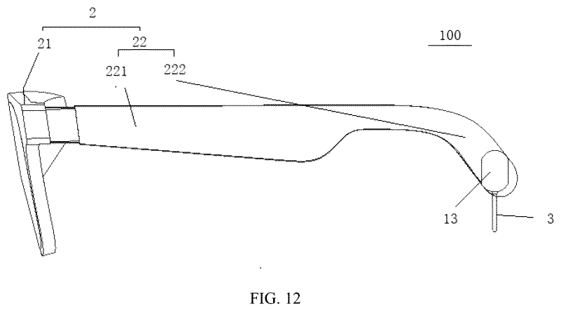

Referring to FIGS. 11 and 12, in the case where the socket 11 is a socket 11 with a rotational angle difference between projections of an outer groove opening 1111a and an inner groove opening 1112a on a horizontal plane in the embodiments of the first aspect described above, when a plug 13 of a data cable is inserted into the socket 11, the plug 13 will rotate or swing at a certain angle, thereby adjusting the direction of the data cable, such that the data cable enters a naturally sagging state. For example, in a state where the plug 13 is connected to the socket 11, an included angle between an end of a cable 3 connected to the plug 13 and a temple main body 221 may be A, where A is greater than or equal to 90° and less than or equal to 120°. In this way, the overall product form is neat during use of the smart glasses 100, which significantly improves the user experience.

Embodiments of the present disclosure further provide a socket 11. The socket 11 includes: a connecting groove 111 in communication with the outside, and an extension clamping groove 1112c connected to the outside via the connecting groove 111. Optionally, the connecting groove 111 may include an inner groove portion 1112 and an outer groove portion 1111. The socket 11 further includes a socket terminal 112 arranged in the connecting groove 111, and a first magnetic component 113 arranged in the connecting groove 111 and the extension clamping groove 1112c. The socket 11 is configured in such a way that when a plug 13 having a protruding portion 1322a and a second magnetic component 1322 is placed into the connecting groove 111, the plug 13 is movable relative to the socket 11 under the interaction between the first magnetic component 113 and the second magnetic component 1322, such that a protruding portion 1322a is clamped into the extension clamping groove 1112c of the socket 11, and the socket terminal 112 comes into electrical contact with a plug terminal 1321 of the plug 13, so as to transmit at least one of data and electric energy. Optionally, the second magnetic component 1322 of the plug 13 has the protruding portion 1322a, that is to say, the protruding portion 1322a is also a magnetic part.

Embodiments of the present disclosure further provide a socket 11. The socket 11 includes a connecting groove 111. The connecting groove includes: an outer groove portion 1111 in communication with the outside, and an inner groove portion 1112, wherein the inner groove portion 1112 is in communication with the outer groove portion 1111, and projections of the inner groove portion 1112 and the outer groove portion 1111 on a plane perpendicular to a depth direction of the connecting groove do not overlap, such that the inner groove portion 1112 has a portion communicated but not overlapped with the outer groove portion 1111; and a socket terminal 112 and a first magnetic component 113 arranged in the inner groove portion 1112. The socket 11 is configured in such a way that when a plug 13 having a protruding portion 1322a and a second magnetic component 1322 is placed into the connecting groove 111, the plug 13 is movable relative to the socket 13 under the interaction between the first magnetic component 113 and the second magnetic component 1322, such that the protruding portion 1322a is clamped into the portion of the inner groove portion 1112 not overlapped with the outer groove portion 1111, and the socket terminal 112 comes into electrical contact with a plug terminal 1321 of the plug 13, so as to transmit at least one of data and electric energy.

The above description has been made for purposes of illustration and description. In addition, this description is not intended to limit the embodiments of the present disclosure to the forms disclosed herein. Although a plurality of example aspects and embodiments have been discussed above, certain variations, modifications, changes, additions, and sub-combinations thereof would occur to those skilled in the art.

1. A socket, comprising:
a connecting groove comprising:
an outer groove portion, and
an inner groove portion in communication with the outer groove portion, and a limiting surface being formed between the inner groove portion and the outer groove portion;
a socket terminal arranged in the inner groove portion; and
a first magnetic component arranged in the inner groove portion,
wherein the socket is configured in such a way that when a plug having a protruding portion and a second magnetic component is placed into the connecting groove, the plug is movable relative to the socket under the interaction between the first magnetic component and the second magnetic component, such that the protruding portion is clamped onto the limiting surface of the socket, and the socket terminal comes into electrical contact with a plug terminal of the plug, so as to transmit at least one of data and electric energy.

2. The socket according to claim 1, wherein the outer groove portion has an outer groove opening, the inner groove portion has an inner groove opening in communication with the outer groove portion, and the outer groove opening and the inner groove opening are arranged in one of the following two ways:
projections of the outer groove opening and the inner groove opening on a horizontal plane have a rotational angle difference; and
projections of the outer groove opening and the inner groove opening on a horizontal plane have a displacement difference.

3. The socket according to claim 2, wherein both the outer groove opening and the inner groove opening are strip-shaped, and the projections of the inner groove opening and the outer groove opening on the horizontal plane have a distance difference in any of a length direction and a width direction of the outer groove opening.

4. The socket according to claim 3, wherein the inner groove portion has a main groove portion and an extension clamping groove; the main groove portion is in communication with the outer groove portion, the extension clamping groove is in communication with an end of the main groove portion in the length direction, and the limiting surface is formed between the extension clamping groove and the outer groove portion; and
when the plug having the protruding portion on one side in the length direction is placed into the connecting groove, the plug is movable linearly relative to the socket under the interaction between the first magnetic component and the second magnetic component, such that the protruding portion is clamped into the extension clamping groove.

5. The socket according to claim 2, wherein the projections of the outer groove opening and the inner groove opening on the horizontal plane have a rotational angle difference, and a rotation center is arranged in one of the following two ways:
the rotation center is a center point of the projections of the outer groove opening and the inner groove opening on the horizontal plane; and
the rotation center is an intersection point of outer contour lines of the projections of the outer groove opening and the inner groove opening on the horizontal plane.

6. The socket according to claim 5, wherein the rotation center is a center point of the projections of the outer groove opening and the inner groove opening on the horizontal plane; the inner groove portion has a main groove portion and two extension clamping grooves; the main groove portion is in communication with the outer groove portion, the extension clamping grooves are in communication with the main groove portion, and the two extension clamping grooves are respectively provided on two sides of the outer groove portion in a diagonal direction; and
when the plug having a protruding portion on each of two sides in the diagonal direction is placed into the connecting groove, the plug is rotatable relative to the socket under the interaction between the first magnetic component and the second magnetic component, such that the two protruding portions are respectively clamped into the two extension clamping grooves.

7. The socket according to claim 5, wherein the rotation center is an intersection point of outer contour lines of the projections of the outer groove opening and the inner groove opening on the horizontal plane; the inner groove portion has a main groove portion and an extension clamping groove; the main groove portion is in communication with the outer groove portion, the extension clamping groove is in communication with the main groove portion, and the extension clamping groove is located on one side of the outer groove portion in a diagonal direction; and
when the plug having the protruding portion on one side in the diagonal direction is placed into the connecting groove, one end of the plug swings, under the interaction between the first magnetic component and the second magnetic component, until the protruding portion is clamped into the extension clamping groove.

8. The socket according to claim 1, wherein the first magnetic component is disposed circumferentially along a rim of the inner groove portion, a recess is defined along a rim of a bottom wall of the inner groove portion, and the first magnetic component is embedded in the recess.

9. The socket according to claim 1, wherein the inner groove portion has:
a main groove portion in communication with the outer groove portion, the socket terminal being arranged in the main groove portion; and
an extension clamping groove in communication with the main groove portion, wherein the limiting surface is formed between the extension clamping groove and the outer groove portion, the first magnetic component is arranged in the main groove portion and the extension clamping groove, and the first magnetic component is located closer to an outer edge of the socket than the socket terminal.

10. A plug, comprising:
a plug body having a plug terminal and a second magnetic component surrounding the plug terminal, the second magnetic component being formed with a protruding portion,
wherein, when the plug body is placed into a socket with a connecting groove, the plug body is movable relative to the socket under the interaction between a first magnetic component of the socket and the second magnetic component, such that the protruding portion is clamped onto a limiting surface in the connecting groove, and the plug terminal comes into electrical contact with a socket terminal in the socket, so as to transmit at least one of data and electric energy.

11. The plug according to claim 10, wherein the protruding portion is arranged in one of the following three ways:
the protruding portion is located on one side of the plug body in a length direction;
the protruding portion is located on one side of the plug body in a diagonal direction; and
the protruding portion is located on two sides of the plug body in a diagonal direction.

12. The plug according to claim 10, wherein the plug comprises a plug seat, the plug body being connected to the plug seat, the plug seat having a cross-section larger than that of the plug body; and
the plug is configured in such a way that in a state where the plug body is connected to the connecting groove, the plug seat covers the connecting groove.

13. A connector assembly, comprising:
a socket, comprising:
an outer groove portion,
an inner groove portion in communication with the outer groove portion, and a limiting surface being formed between the inner groove portion and the outer groove portion,
a socket terminal arranged in the inner groove portion,
a first magnetic component arranged in the inner groove portion, and
a plug body having a plug terminal and a second magnetic component surrounding the plug terminal, the second magnetic component being formed with a protruding portion,
wherein, when the plug is placed into the connecting groove, the plug is movable relative to the socket under the interaction between the first magnetic component and the second magnetic component, such that the protruding portion is clamped onto the limiting surface of the socket, and the socket terminal comes into electrical contact with the plug terminal of the plug, so as to transmit at least one of data and electric energy.

14-15. (canceled)

16. The connector assembly according to claim 13, wherein the outer groove portion has an outer groove opening, the inner groove portion has an inner groove opening in communication with the outer groove portion, and the outer groove opening and the inner groove opening are arranged in one of the following two ways:
projections of the outer groove opening and the inner groove opening on a horizontal plane have a rotational angle difference; and
projections of the outer groove opening and the inner groove opening on a horizontal plane have a displacement difference.

17. The connector assembly to claim 16, wherein both the outer groove opening and the inner groove opening are strip-shaped, and the projections of the inner groove opening and the outer groove opening on the horizontal plane have a distance difference in any of a length direction and a width direction of the outer groove opening.

18. The connector assembly to claim 17, wherein the inner groove portion has a main groove portion and an extension clamping groove; the main groove portion is in communication with the outer groove portion, the extension clamping groove is in communication with an end of the main groove portion in the length direction, and the limiting surface is formed between the extension clamping groove and the outer groove portion; and
when the plug having the protruding portion on one side in the length direction is placed into the connecting groove, the plug is movable linearly relative to the socket under the interaction between the first magnetic component and the second magnetic component, such that the protruding portion is clamped into the extension clamping groove.

19. The connector assembly according to claim 16, wherein the projections of the outer groove opening and the inner groove opening on the horizontal plane have a rotational angle difference, and a rotation center is arranged in one of the following two ways:
the rotation center is a center point of the projections of the outer groove opening and the inner groove opening on the horizontal plane; and
the rotation center is an intersection point of outer contour lines of the projections of the outer groove opening and the inner groove opening on the horizontal plane.

20. The connector assembly according to claim 19, wherein the rotation center is a center point of the projections of the outer groove opening and the inner groove opening on the horizontal plane; the inner groove portion has a main groove portion and two extension clamping grooves; the main groove portion is in communication with the outer groove portion, the extension clamping grooves are in communication with the main groove portion, and the two extension clamping grooves are respectively provided on two sides of the outer groove portion in a diagonal direction; and
when the plug having a protruding portion on each of two sides in the diagonal direction is placed into the connecting groove, the plug is rotatable relative to the socket under the interaction between the first magnetic component and the second magnetic component, such that the two protruding portions are respectively clamped into the two extension clamping grooves.

21. The connector assembly according to claim 19, wherein the rotation center is an intersection point of outer contour lines of the projections of the outer groove opening and the inner groove opening on the horizontal plane; the inner groove portion has a main groove portion and an extension clamping groove; the main groove portion is in communication with the outer groove portion, the extension clamping groove is in communication with the main groove portion, and the extension clamping groove is located on one side of the outer groove portion in a diagonal direction; and
when the plug having the protruding portion on one side in the diagonal direction is placed into the connecting groove, one end of the plug swings, under the interaction between the first magnetic component and the second magnetic component, until the protruding portion is clamped into the extension clamping groove.

22. The connector assembly according to claim 13, wherein the first magnetic component is disposed circumferentially along a rim of the inner groove portion, a recess is defined along a rim of a bottom wall of the inner groove portion, and the first magnetic component is embedded in the recess.
